(19) United States
(12) Patent Application Publication
(10) Pub. No.: US 2009/0017433 A1
(43) Pub. Date: Jan. 15, 2009

(54) Computerized method of monitoring and modifying student performance

(76) Inventors: Jeffrey Belsky, Moon Township, PA (US); Eileen M. Riley, Pittsburgh, PA (US); Mark A. Scott, Edgeworth, PA (US); David D. Semich, Coraopolis, PA (US)

Correspondence Address: ECKERT SEAMANS CHERIN & MELLOTT, 600 GRANT STREET, 44TH FLOOR, PITTSBURGH, PA, 15219, US

(21) Appl. No.: 11/827,058

(22) Filed: Jul. 10, 2007

(51) Int. Cl. G09B 7/00

(52) U.S. Cl. 434/362

(57) ABSTRACT

A computerized method of monitoring and modifying student performance may include collecting student information from a plurality of sources, storing the information electronically in a retrievable form, and reviewing the student information for student issues, which may have a negative impact on performance of a student. If such student issues exist, communicating with a student regarding the same, creating an action plan to improve or terminate the student issues, and implementing the action plan. Time factors, the specific student issues, the student information, including prior history and collaboration of appropriate student advisors, are combined to establish and implement the action plan. This is followed by monitoring of the student of interest in respect of certain student issues, updating student information, and applying time factors related to individual issues in the monitoring of such subsequent student performance.

### BACKGROUND OF THE INVENTION

1. Field of the Invention

The present invention relates to a computerized method of monitoring and modifying student performance so as to enhance such performance and increase the likelihood of the students successfully accomplishing the educational objectives of the school and student.

2. Description of the Prior Art

It has been known, at various levels of formal education, to have teachers monitor student performance through student observation, reviewing of classroom performance and assignments, providing appropriate assessments, monitoring behavior, and providing feedback to students and parents.

It has also been known for teachers and administrators to have meetings with students and/or parents with a view toward solving problems which the student is experiencing, which may, for example, be academic or behavioral.

The known methods of dealing with such situations have typically been unstructured in nature and very subjective in evaluation and application.

There remains, therefore, a very real and substantial need for a computerized and structured method of monitoring student performance with particular emphasis on certain student issues and to provide means for effective communication, establishment of action plans, and monitoring subsequent performance.

### SUMMARY OF THE INVENTION

The present invention has satisfied the above-described need by providing a computerized and structured method of monitoring student performance, which includes collecting student information from a plurality of sources, storing the student information in an electronically-retrievable manner, and reviewing by personnel of the student information for student issues which may have a negative impact on student performance. If such student issues exist, the method contemplates communicating with the student regarding the same, creating and implementing an action plan to improve or resolve the student issues, and implementing the action plan.

In a preferred embodiment of the invention, communication between or among student advisors may precede communication with the student of interest. The timing and content of communications, performance of items on the action plan, and periodic reviews with updating of the student information may be determined on an issue-by-issue basis.

Among the items which may be a portion of the action plan, for example, could be counseling of the student, tutoring of the student, enhanced monitoring of classroom performance, performance in extracurricular activities, and combinations thereof.

The method contemplates periodic review of student information on all students and periodic updating of the student information database.

It is an object of the present invention to provide a computerized method of monitoring student performance in order to determine whether student issues, making it desirable for intervention, exist.

It is another object of the present invention to provide a method, which is proactive in detecting and managing student issues.

It is another object of the present invention to monitor student performance with specific emphasis on certain aspects of the student in order to provide prompt and effective intervention in the event departures from the desired performance exist or are likely to occur.

It is yet another object of the present invention to provide such a method, wherein computerized storage and processing of student information facilitates rapid monitoring and action to resolve student issues.

It is a further object of the present invention to provide such a method, wherein specific timing of events in an action plan seeking to eliminate student issues is facilitated in an automated fashion.

It is a further object of the present invention to modify student performance in a positive direction.

These and other objects of the invention will be more fully understood from the following detailed description of the invention on reference to the illustrations appended hereto.

### BRIEF DESCRIPTION OF THE DRAWINGS

FIG. 1 is a schematic illustration of information-gathering portions of the method of the present invention.

FIG. 2 is a schematic illustration of a method of evaluation and taking responsive action of the present invention.

### DESCRIPTION OF THE PREFERRED EMBODIMENTS

As employed herein, the term “student information” means information which is directly or indirectly relevant to a student, either in his or her capacity as a student or performance as a student including, but not limited to, information relating to the student's individual and family biographical information, whether the student is in his or her first quarter in the school, whether the student has previously withdrawn from the school or another school, whether the student is a high-risk to withdraw, whether the student has acceptable attendance, whether the student has acceptable grades, whether the student has had problems within the school or external problems which may impact on the student's success as a student, and whether there are positive factors in the student's background and performance with respect to the school.

As employed herein, the term “student issues” means departures, anticipated departures, or potential departures from standards established by the school correlating with a high probability of a successful experience as a student. This term shall expressly include, but not be limited to, academic issues, social issues, financial issues, behavior issues, and logistical issues.

As employed herein, “student advisors” means people involved in student instruction, school administration, student counseling activities, and others expressly requested by the school to assist with student monitoring, evaluation, counseling, or assistance and shall expressly include, but not be limited to, teachers, assistants, administrators, counselors, and expressly-selected, appointed fellow students.

As employed herein, the term “student of interest” means a student being evaluated for performance measurement purposes and, if desired, assistance with modification of any phase of student performance.

As employed herein, the term “time factor” means a period of time within which monitoring communication with or evaluation of a student of interest should be made.

After a student submits an application for admission and is accepted into the school, certain pre-enrollment activities occur. During orientation, in order to enhance the likelihood of a successful beginning, a great deal of information is obtained from students and/or parents. In addition, the orientation period provides an opportunity for students and parents to build a rapport with representatives of the school and for the school to provide information regarding the academic curriculum, housing, financial matters, and other information of potential interest to parents and students.

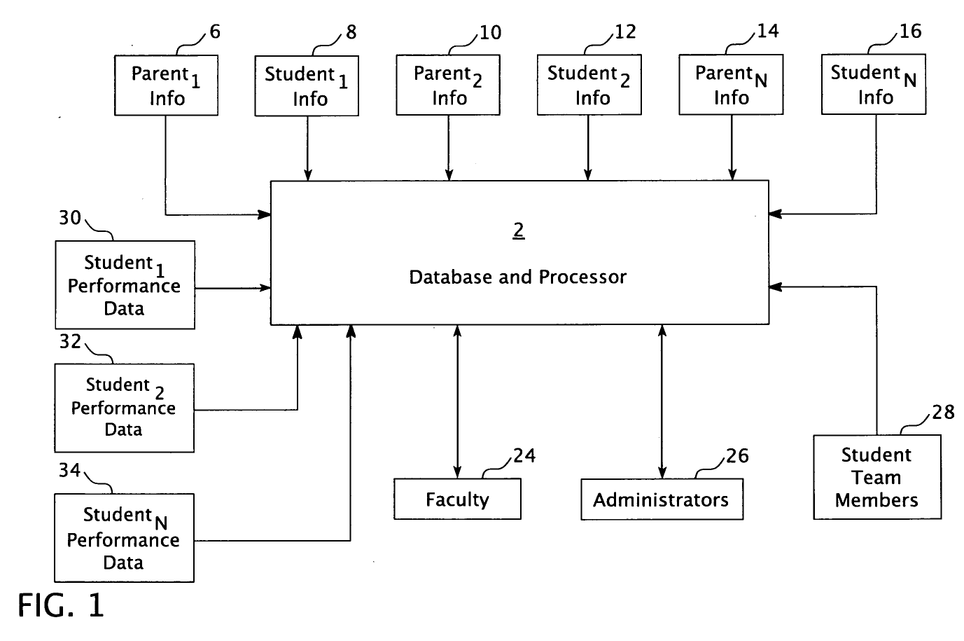

Referring in greater detail to FIG. 1, there is shown a schematic illustration of the introduction of student information into a computer database and processor 2. One source of information with respect to the first student is illustrated as coming from a parent or parents 6 of the first student and the student 8. Similarly, information with respect to a second student is shown as coming from the parent(s) 10 and the student 12. It will be appreciated that any number of students may be involved in intervention, and generally all of the students in the school are the subject of the monitoring process. This is represented generally by showing the information from parent of the Nth parent 14 and Nth student 16. Information provided by the respective parents and students may include specific identification of the people in the family including education, occupation, residence, and prior relationships with the school, if any. Similarly, with respect to the student, the student's full background and profile, residence, anything unusual in the student's background, whether positive or negative, and prior and current educational history may be introduced.

In addition to the foregoing, student information will generally contain information received from faculty 24, administrators 26, and specially-selected student team members 28 who have been brought into the process. Also, individual student performance data from a first student 30, second student 32 up through the Nth student 34 is introduced. It will be appreciated that other information which may be of value in accomplishing the goal of efficient monitoring of performance of individual students, determining if issues exist, and communicating and evaluating such issues may be introduced. This may produce an action plan which is introduced into the database 2. The database and processor 2 will contain appropriate software, well known to those skilled in the art, to effect the desired receipt, organization and storage of student information, recognition and monitoring of student issues, coordinating communications, controlling time factors, reminders, emitting desired processed information, and other desired output employed in the methods of the present invention.

The database and processor 2 preferably also contains global student information involving all current students for purposes of comparison with a particular student's performance in order to facilitate determination if a student issue exists. Similarly, the database and processor 2 may also contain historical information, which may be global in nature and may also be employed as a measuring reference against a specific student issue involving a specific student. The comparisons with current and/or historical data may be effected in the database and processor 2, or in the alternative, the database and processor 2 may generate the information for a comparison by appropriate school representatives.

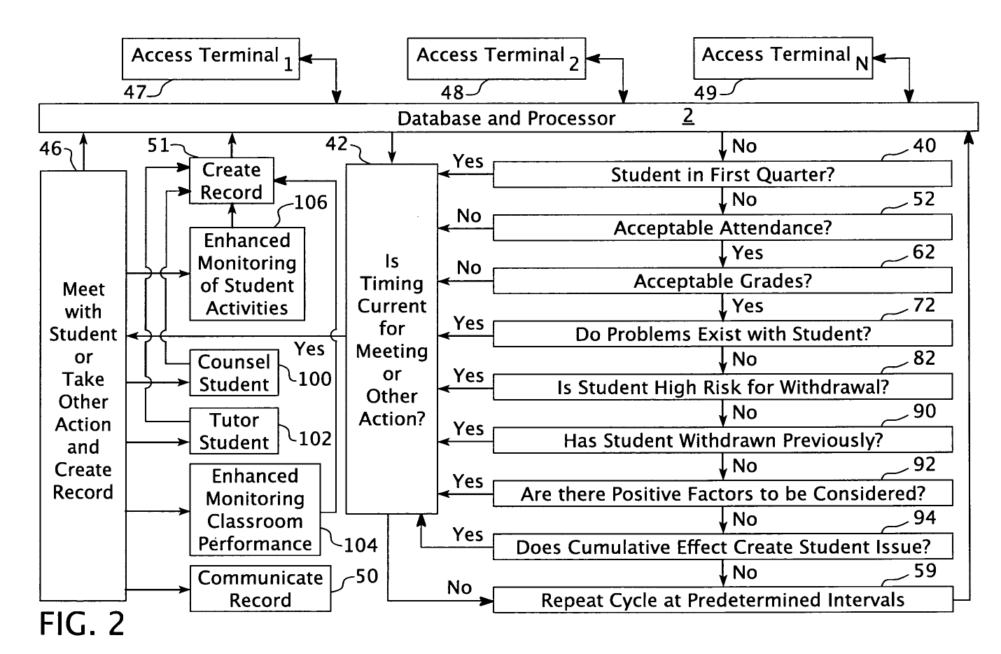

Referring to FIG. 2, there is shown a series of issues, which may be deemed student issues, which could have an impact on a student's performance, either positive or negative. In considering a cycle of operations in respect of these issues, one may input into the database and processor 2 time factors indicating how frequently a given issue should be dealt with both in terms of an initial evaluation, as well as a range of time within which a follow-up should be considered. It is to be understood that student issues are not necessarily limited to those shown in FIG. 2, but that these are among the preferred issues which are monitored.

If a student is in the first quarter of attendance at the school, there is frequently a period of adjustment and an enhanced risk of negative performance. As shown in FIG. 2, it is determined whether a student is in the first quarter 40. If so, output passes to the timing factor monitor 42 to determine if the system should be put into effect at that time in respect of this issue. It is preferred that there be an initial review of such a student and subsequent reviews about every one to two weeks during the first quarter. If the answer is “yes,” there can be a meeting with the student 46 to discuss the same and formulate a plan of action which is designed to enhance the student's performance in the first quarter. Feedback regarding any such meeting is provided to a database and processor 2 in order to create updated student information. Also, a record or report 51 of the meeting may be prepared and accessed from a terminal or access terminal, such as 47, 48, 49, or communicated by way of a tangible hard-copy record 50.

Suitable security measures limiting access to all or portions of the system, such as gatekeeper user identification and passwords, may be employed.

The system will consider whether the student has had acceptable attendance 52. If the answer is “no,” the question of timing 42 is considered. With any negative answer on this issue, the next step is to repeat the cycle 59 of evaluating the various student issue parameters at predetermined intervals. Feedback is provided to the database and processor 2 from the repeat cycle 59 at predetermined intervals. If the timing 42 is correct in respect of acceptable attendance 52, the meeting approach 46 is next. With respect to meetings and communications among student advisors, it is generally desirable to have one or more student advisors interact with each other prior to the meeting with the student 46. This makes sure that input is provided from all relevant sources to maximize the effectiveness of any action plan. When a student has an undesirable attendance record, a faculty member or administrator, who has been designated for the purpose, will contact the student with a view toward identifying reasons for the absence, ascertain any student issues related thereto, and provide information regarding class work missed. This latter function requires the input of each faculty member whose class was missed during a student absence. A further student issue to be evaluated is whether the student has acceptable grades 62. If not, the timing 42 of taking action is considered with the same sequence of events in respect of student advisors conferring and subsequent a meeting with the student. It will be appreciated that the meeting with the student may, at the election of the student advisors, include one or more parents.

If problems exist with the student 72 in respect of academics, behavior, home problems, or other problems, the timing module 42 is considered with the same follow-through in respect of meeting of student advisers and with the student 46.

If the student is at a high risk for withdrawal 82, this is another factor which is taken into consideration and evaluated. Also, if the student has previously withdrawn 90 from that school or another school, this, too, is taken into consideration.

When a student is at high risk for withdraw, the cycle of inquiry with particular emphasis on blocks 52, 62, 72, 82, 90 would all be processed on a frequent basis and preferably no less frequently than weekly; although, meetings with the student 46 may not always occur with that frequency unless the evaluations result in the conclusion that immediate action, such as meeting 46 and some of the remedial activities, such as blocks 100, 102, 104, 106 are deemed desirable. Early identification of attributes which would put a student in the high risk of withdrawal category will tend to contribute to reducing the risk of withdrawal. For example, if the student information contained within database and processor 2 shows that a given student has a learning disability, such as ADD, ADHD, or has simply had educational difficulties at the high school level, proactive efforts to minimize the risk of failure can be taken. The initial information gathering process, as discussed in connection with the example of FIG. 1, can be very important in determining, at an early stage, what problems may contribute to an unsuccessful performance and/or withdrawal of a student. Among the types of factors considered would be high school individual education plans, potential learning disabilities, social problems, transportation, housing, family matters, or other concerns, which may include the student's success. Unique student personality characteristics and preferences can also be considered.

If there are positive factors 92 which need to be considered, the processors can then be programming so as to override or partially override negative issues.

With respect to the factors 40, 52, 62, 72, 82, 90, the database and processor 2 may be so programmed that even though a student is not at the negative level in any of the student issues, there may be a determination that the student is approaching the boundary of negative performance in a plurality of such issues. If so, the cumulative effect 94 may lead to the conclusion that a student issue exists. The timing 42 module may be followed by communication and meeting with student 46.

It will be appreciated that while the sequence of student issues 40, 52, 62, 72, 82, 90, 92 is shown in an illustrative sequence in FIG. 2, it need not be evaluated in that sequence. Also, additional factors may be evaluated, if desired.

Referring still to FIG. 2, the action plan items may include prescribing counseling 100 for the student. If academic problems are involved, tutoring 102 of the student may be provided. If behavior problems exist, enhanced monitoring 104 of classroom performance may be part of the plan. Also, if problems that occurred are in school-related activities, enhanced monitoring of such activities 106 may be provided.

If an action plan is created, the updated information about said student is preferably reviewed about every one to two weeks. It will be appreciated that the method of the present invention provides a computerized method for determining when it is desirable for a student of interest to have specialized attention. It is also important to know when the special attention can be withdrawn as a result of the student making sufficient progress to minimize the risk.

It will be appreciated that the method, exemplified by FIG. 2, will preferably be in effect for all students for their entire period of matriculation at the school with the exception of the evaluation and special attention caused solely by the student being in the first quarter of attendance at the school. When a student issue is the student being in the first quarter at the school, a method is employed as to that specific student issue only during a portion of the first year of the student's academic life.

It is generally preferred that, insofar as faculty members are involved in the method as student advisors, they are faculty members who teach in the same quarter and have substantially the same student body for that quarter, as this enables them to prepare evaluations of a specific student more effectively. If a student is in the first quarter, as indicated by a “yes” answer in respect of block 20, the timing 42 will generally be such that carefully-selected students will have one or more meetings with one or more other senior students in order that the first quarter students can have a comfort level by knowing current students. It is generally preferred that a volunteer student be provided with an orientation program regarding the logistics of interacting with first quarter students and be assigned to one or more such students for ongoing mentoring.

It will be appreciated that while the method of the present invention may be useful in a wide variety of educational institutions, it will be particularly advantageous with respect to post-high school education.

In summary, the method of the present invention permits the system to store information regarding a student and automatically and rapidly provides feedback regarding potential danger signs in the nature of student issues, which either are having a negative impact on the student's performance or are likely to and to permit timely intervention with respect to the same.

It will be appreciated, as will be known to those skilled in the art, that any suitable arrangement with the database and processor 2, as well as access terminals, may be employed in the method of the invention to provide the desired functionality.

Whereas particular embodiments of the invention have been described herein, for purposes of illustration, it will be evident to those skilled in art that numerous variations of the details may be made without departing from the invention as set forth in the appended claims.

What is claimed is:

1. A computerized method of monitoring student performance comprising:
collecting student information from a plurality of sources,
storing said student information in an electronically-retrievable manner,
periodically reviewing said student information for student issues which may have an impact on performance of said student,
if a said student issue exists, communicating with said student regarding the same,
creating an action plan to improve said student's performance in respect of said student issues, and
implementing said action plan.

2. The method of claim 1 including
after determining that a student issue exists and prior to said communication with said student establishing communication with a plurality of advisors with a view toward developing said action plan.

3. The method of claim 2 including
periodically updating said student information.

4. The method of claim 3 including
periodically reviewing said updated information, and
if student issues which may have a negative impact on said student's performance exist repeating said communication steps and said implementation step with respect to said student.

5. The method of claim 1 including
said action plan includes at least one activity selected from the group consisting of counseling said student, tutoring said student, enhanced monitoring of said student's classroom performance, and enhanced monitoring of activities of said student.

6. The method of claim 1 wherein said student issues include at least one issue selected from the group consisting of whether the student is in his or her first quarter at the school, whether the student has had acceptable attendance, whether the student has had acceptable grades, and whether any problems exist with respect to said student.

7. The method of claim 1 including
wherein said student issues include at least one issue selected from the group consisting of: whether the student is a high-risk for withdrawal from the school and whether the student has withdrawn previously from a school.

8. The method of claim 1 including
determining whether said student issues include factors which could have a positive impact on the student's performance.

9. The method of claim 6 including wherein if said student is in his or her first quarter in said school, effecting an initial review of said student information for student issues and subsequent reviews about every one to two weeks thereafter during said first quarter.

10. The method of claim 1 including
if said periodic review results in the conclusion that at least one student issue which may have a negative impact on student performance exists updating said student information.

11. The method of claim 1 including
if a said periodic review results in the conclusion that at least one student issue, which may have a negative impact on student performance exists, creating a written report.

12. The method of claim 10 including
wherein if an action plan is created, monitoring said student's performance under said action plan about every one to two weeks.

13. The computerized method of claim 1 including
employing said method on substantially all said students.

14. The computerized method of claim 1 including
proceeding with the evaluation and action plan, even though a plurality of student issues has none of them negative but the cumulative effect of said student issues is sufficiently close to being negative as to make it desirable to go through the evaluation process.

15. The computerized method of claim 5 including
said activities include school-related activities and activities which are unrelated to the school.

16. The computerized method of claim 14 including
employing factors which could have a positive impact in determining said cumulative effect.

17. The computerized method of claim 11 including
providing said student with a copy of said written report.

18. The computerized method of claim 1 including
employing said method for students at the post-high school level.

19. The computerized method of claim 18 including
employing said method generally throughout the academic life cycle of said student.

20. The computerized method of claim 6 including
when a specific student issue is a student being in the first quarter at the school, employing said method as to said specific student issue only during a portion of the first year of the student's academic life.
